(19) United States
(12) Patent Application Publication
(10) Pub. No.: US 2010/0307947 A1
(43) Pub. Date: Dec. 9, 2010

(54) EXTENDED TEXT SHRINK SLEEVE

(75) Inventors: Donna MARDEN, Seven Valleys, PA (US); Craig CLARK, Lancaster, PA (US)

Correspondence Address: MCNEES WALLACE & NURICK LLC, 100 PINE STREET, P.O. BOX 1166, HARRISBURG, PA, 17108-1166, US

(73) Assignee: C-P FLEXIBLE PACKAGING, York, PA (US)

(21) Appl. No.: 12/782,195

(22) Filed: May 18, 2010

Related U.S. Application Data
(60) Provisional application No. 61/185,008, filed on Jun. 8, 2009.

(51) Int. Cl. B65D 85/00; B42D 15/00; B29C 65/00

(52) U.S. Cl. 206/459.5; 283/81; 156/227

(57) ABSTRACT

A resealable extended text film panel system. The resealable extended text film panel comprises a shrink sleeve portion and a film text panel. The shrink sleeve portion is integral with the film text panel so that the film text panel is not readily removed from the shrink sleeve portion. A seam is formed between the integral shrink sleeve portion and a first end of the film text panel that delineates the film text panel from the shrink sleeve portion. A resealable strip is affixed to an edge of the film text panel. This resealable strip permits the film text panel to cooperate with the shrink sleeve portion, allowing the film text panel to be unsealed and sealed to the shrink sleeve portion a plurality of times, allowing the printable material on the shrink sleeve portion and on the film text panel to be read by a user as frequently as desired. The resealable strip can be applied to the film text panel or to a portion of the shrink sleeve portion underlying the film text panel. A method of forming the resealable extended text film panel system is also provided.

### FIELD OF THE INVENTION

The present invention is directed to labeling applied to packaging, and more specifically to an extended shrink sleeve label that includes a resealable panel that permits the inclusion of additional text.

### BACKGROUND

Labels are currently applied to packaging such as containers by standard shrink sleeve processes. These processes involve printing labels with the desired information, which may include product identification and instructions for use of the product. Printing is usually performed on a printable and shrinkable material such as polyvinyl chloride (PVC) sheet. After printing, the labels are seamed, usually with an adhesive/solvent, to form a standard shrink sleeve. These labels are printed in this fashion by the printer and then shipped to the product manufacturer. The product manufacturer typically applies the labels to the container packaging. The labels are placed over the packaging and contracted, or shrunk, to fit tightly around the container. Alternatively, or in addition, the product packaging may be provided with an adhesive/solvent to assure there is no movement of the label once applied to the container. This is standard, current state of the art, shrink sleeve processing. Since the labels are usually heated to an elevated temperature during the shrink sleeve processing, a heat-activated adhesive is suitably applied for such applications when no label movement or removal is specified, although the adhesive employed is not limited to heat-activated adhesives. One of the limitations of the current shrink sleeve process for labeling is that the printing area is limited to space available on the outer surface of the container or packaging. If additional information is required, it must be provided by some other means.

U.S. Pat. No. 5,800,893 to Harden, issued on Sep. 1, 1998, discloses a double blinded label applied adhered to a container. The double blinded label includes a first section and a second section. The second section is held to the container with an adhesive. The first section which includes a blinding label is removed from the second section which remains on the container by tearing along perforations. The second section includes an adhesive allowing it to be attached to a record with the blind in place. The blind can be removed if necessary to expose the information underlying it.

One extended text concept is depicted in FIG. 1. In the concept depicted in FIG. 1, text is printed on a plurality of pages, each page being pressure sensitive material. This printed pressure sensitive material is then applied to a shrink-fit label. The pressure sensitive pages may even be adhered to the shrink-fit label in one or more corners. However, since the pressure sensitive pages are not integral and can be peeled from the label or the container, thereby resulting in a loss of the instructions, which can be vital for prescription drug applications, it is necessary to provide additional instructions on a box containing the product, or it is necessary to provide duplicate instructions in another manner. Loss of these additional instructions can make the product unsafe or unusable. U.S. Pat. No. 7,357,422 to Seidl issued Apr. 15, 2008, is exemplary of this arrangement. Printed information carries in the form of a booklet which is adhered to the container and covered by the label which can be peeled back so that the booklet can be removed, reviewed, replaced and rewrapped.

U.S. Pat. No. 7,114,446 to Sellars issued Oct. 3, 2006, discloses a method for providing a label suitable for being adhered about an object once removed from the release liner, the label having a length greater than the circumference of the object and the release liner providing a mechanical support for the label prior to being adhered about the object, the method including: printing at least a portion of the label with indicia; printing at least a portion of the release liner with indicia, and at least partially severing the printed portion of the release liner from the release liner such that upon removal of the label from the release liner, the printed portion of the release liner remains releasably adhered to the label.

U.S. Patent Publication 2009/0206594 published Aug. 20, 2009, discloses a folded label produced without the necessity of adhering any portions of a sheet to each other. The label uses only one sheet having display contents described on predetermined portions of both sides thereof. The label is formed by folding the sheet. The label is formed without any portions of the sheet adhered to each other, without any portions of the sheet adhered to each other.

What is needed is a product label that can provide extended text information while at the same time is not readily removed from the label. Other features and advantages of the present invention will be apparent from the following more detailed description of the preferred embodiment, taken in conjunction with the accompanying drawings which illustrate, by way of example, the principles of the invention.

### SUMMARY

A resealable extended text film panel system is provided. The resealable extended text film panel comprises a shrink sleeve portion and a film text panel. The shrink sleeve portion is integral with the film text panel so that the film text panel is not readily removed from the shrink sleeve portion. A seam is formed between the integral shrink sleeve portion and a first end of the film text panel that delineates the film text panel from the shrink sleeve portion. A resealable strip is affixed to an edge of the film text panel away from the seam. This resealable strip permits the film text panel to cooperate with the shrink sleeve portion, allowing the film text panel to be unsealed and sealed to the shrink sleeve portion a plurality of times, allowing the printed material on the shrink sleeve portion and on the film text panel to be read by a user as frequently as desired. The resealable strip can be applied to the film text panel or to a portion of the shrink sleeve portion underlying the film text panel.

A packaging system comprises a package having an exterior surface. A resealable extended film text panel system is applied to the package. The resealable extended film text panel system includes a sleeve portion that extends around the exterior surface of the package. A film text panel is integral with the sleeve portion. A seam is formed between the sleeve portion and a first end of the film text panel, the film text panel extending away from the seam. The film text panel that extends away from the seam overlaps a section of the sleeve portion, the section of the sleeve portion that is overlapped being equal to the amount of the film text panel that extends away from the seam. A resealable strip cooperates with the film text panel so that the film text panel can be unsealed from and sealed to the sleeve portion a plurality of times. The resealable strip is attached to either the film text panel or to the section of the sleeve portion underlying the overlapping film text panel. The film text panel and at least the section of the sleeve portion overlapped by the film text panel may include printable material.

An advantage of the present invention is that since the shrink sleeve portion is integral with the film text panel, the film text panel cannot readily be removed from the shrink sleeve portion. The result is that the film text panel and any instructions can only be removed from the container intentionally, for example, by cutting off the shrink sleeve portion and hence the film text panel.

Another advantage of the present invention is that it is no longer necessary to provide a second set of instructions with the packaging, since instructions provided on the film text panel are substantially permanently associated with the package or container.

Still another advantage of the present invention is that area is available for printing on the shrink sleeve portion, and additional area is available on the film text panel for additional instruction because of the arrangement of the film text panel with respect to the shrink sleeve portion.

### DESCRIPTION OF THE DRAWINGS

FIG. 1 depicts a typical prior art extended text label currently in the market.

FIG. 2 depicts an extended text shrink sleeve of the present invention with no resealable strip.

FIG. 3 depicts an extended text shrink sleeve of the present invention with a resealable strip and the top edge pulled back prior to application to packaging.

FIG. 4 depicts the extended text shrink sleeve of FIG. 2 after application to packaging.

FIG. 5 depicts the extended text shrink sleeve of FIG. 3 after application to packaging with the top edge of the resealable strip pulled back.

FIG. 6 depicts a roll of material used to form the extended text shrink sleeve of the present invention.

FIG. 7 depicts the width of a single extended text shrink sleeve with folds to illustrate fabrication of the present invention into an extended text shrink sleeve.

FIG. 8 depicts the formation of a seam in the extended text shrink sleeve.

FIG. 9 depicts a portion of the extended text shrink sleeve with the resealable strip applied.

FIG. 10 depicts a portion of the extended text shrink sleeve of FIG. 9 with the film text panel open.

FIG. 11 depicts an elastically elongated extended text shrink sleeve applied to a bottle.

FIG. 12 depicts an extended text shrink sleeve shrunk fit onto the bottle of FIG. 11.

FIG. 13 depicts the extended text shrink sleeve of FIG. 12 with the film text panel opened to display printed material in the extended text region and on the sleeve portion.

FIG. 14 depicts the extended text shrink sleeve of FIG. 12 or FIG. 13 with the film text panel being resealed onto the shrink portion of the extended text shrink sleeve.

FIG. 15 is a view of automated machinery for forming extended text shrink sleeve of the present invention, the machinery applying an adhesive to the roll of FIG. 6 after folding a length of the roll in accordance with FIG. 7.

FIG. 16 depicts a seaming needle developed for applying an adhesive to form a seam in an automated process for fabricating the extended text shrink sleeve of the present invention.

FIG. 17 depicts a roll of resealable strip assembled to the automated machinery for fabricating the extended text shrink sleeve the present invention.

FIG. 18 depicts application of the resealable strip to the extended text shrink sleeve thereby completing the extended text shrink sleeve of the present invention.

FIG. 19 is a perspective view of a fabricated extended text shrink sleeve prior to application to container.

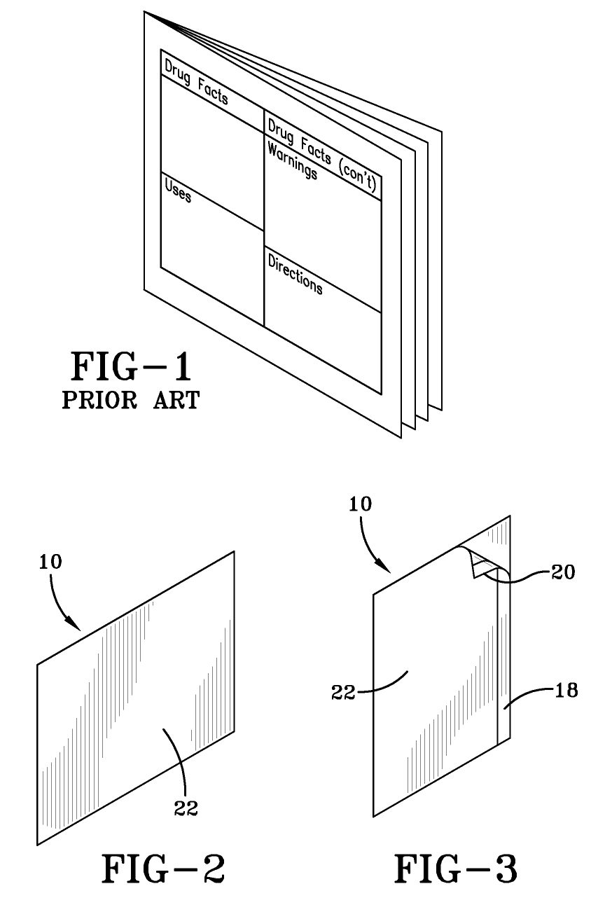

### DESCRIPTION OF THE INVENTION

The present invention is directed to a label that includes a resealable extended text film panel that holds additional text and/or copy. The label material is capable of being stretched or elongated. The label material is first stretched in a transverse direction so that it is extended dimensionally in this direction. The material used for labels preferably has a size or shape memory so that it will attempt to return to its original size or shape usually upon application of heat. The material usually is procured in the elongated condition, but may be stretched, or elongated, by the graphics vendor so the text and/or copy is applied to the material in its stretched condition. Allowance is made when applying text or graphics for shrinkage of the printed material as the label material returns to its original shape or size. The resealable extended text film panel, once applied to the packaging or cartons, is integral with the label and is not readily separable from the label. Thus, it is not necessary to provide additional labeling on packaging or cartons as a contingency in the event that extended text instructions provided with the label are separated. As used herein, packaging or cartons refers to bottles, boxes, containers, jars, cans or other vessels used to transport, ship, convey, hold, contain or deliver product. The resealable extended text film panel preferably is provided as an integral part of a shrink sleeve label. The shrink sleeve label that includes a resealable extended text film panel is referred to herein as an extended text shrink sleeve. The resealable strip that forms part of the extended text film panel includes any strip that reseals to itself, including but not limited to pressure sensitive adhesive strip, Velcro® strip, magnetic strip, static recharge strip and the like.

FIG. 2 illustrates an extended text shrink sleeve of the present invention prior to application to packaging and without a resealable strip. This embodiment simply shows the white plastic material that may be used as a label or film text panel 22 for use with an extended text shrink sleeve 10. The extended text shrink sleeve comprises a white opaque material which will display contrasting, printed text. However, the extended text shrink sleeve is not so restricted, as any other color material may be chosen, including translucent material or clear material, provided the combination of text printing ink and background is selected to permit text printed on the material to be read. Background may be provided by the packaging itself.

FIG. 3 depicts an extended text shrink sleeve 10 of the present invention with a resealable strip 18. The top right edge 20 of the film text panel 22 is pulled back to illustrate how the extended text printing information on sleeve portion underlying the film text panel can be accessed. The resealable strip 18 includes an adhesive selected based on its ability to be resealed after a seal is broken, although, as noted above, resealing is not restricted to adhesive means. The resealable strip 18 is capable of being resealed a plurality of times, and not a single time. This enables the film text panel to be opened to access printed instructions and then resealed. Preferably, the resealable strip 18 can be cycled by opening it, resealing 6 to 12 times, and more preferably, at least 20 times. When an adhesive is used, it preferably is a pressure-sensitive adhesive.

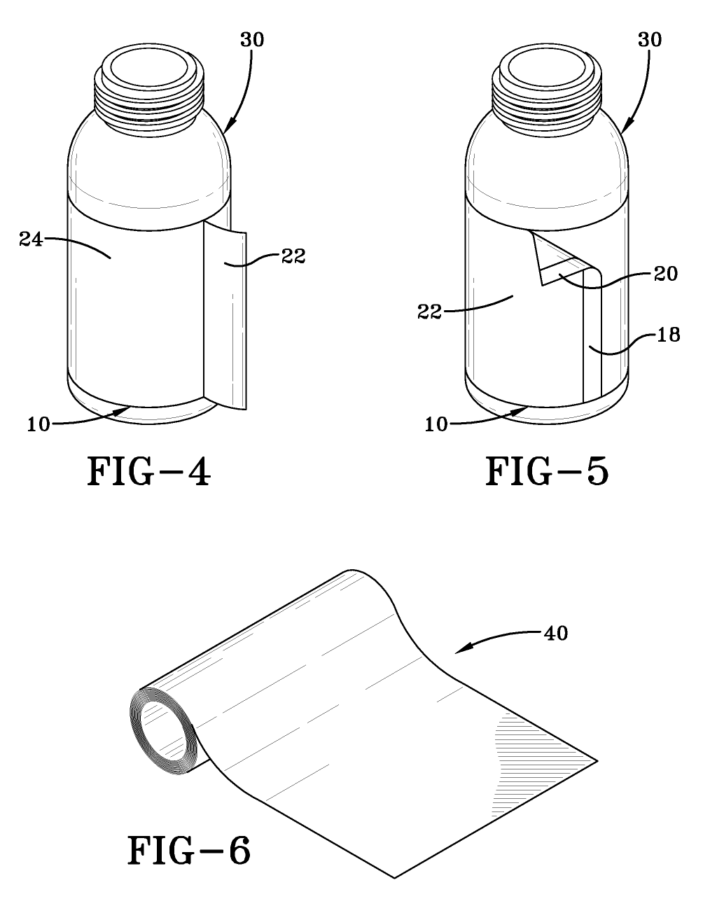

FIG. 4 depicts the extended text shrink sleeve 10 of FIG. 2 after application to packaging. In this figure, the packaging is a bottle 30, and film text panel 22 extends from the shrink seal label. However, in FIG. 4, the extended text shrink sleeve 10 does not yet include a resealable strip 18.

FIG. 5 depicts the extended text shrink sleeve 10 of FIG. 3 after application to packaging. In this figure, the packaging is a bottle 30. As previously noted, the packaging may take the form of any other vessel. Extended text shrink sleeve 10 has been applied to bottle 30 by a shrink fit process. As in FIG. 3, film text panel 22 is adhered with resealable strip 18, although film text panel 22 is pulled back at its top right edge 20 merely to illustrate how any extended text printing information can readily be accessed.

FIG. 6 depicts a roll of material 40 used to form the extended text shrink sleeve of the present invention. The width of the roll of material 40 is selected based on the size (circumference) of the container, such as bottle 30 in FIG. 5, plus the desired width of film text panel 22. The material typically is a thermoplastic polymer, although any material upon which printing may be applied and that can be shrunk fit onto a container may be used. Preferably, the material is selected from the group consisting of a polyvinyl chloride (PVC), a polyethylene terephthalate (PETG), oriented polystyrene (OPS) and polylactide (PLA). As will be explained, the material can be unrolled, printed upon and shrunk fit onto a container to form the extended text shrink sleeve 10 of the present invention.

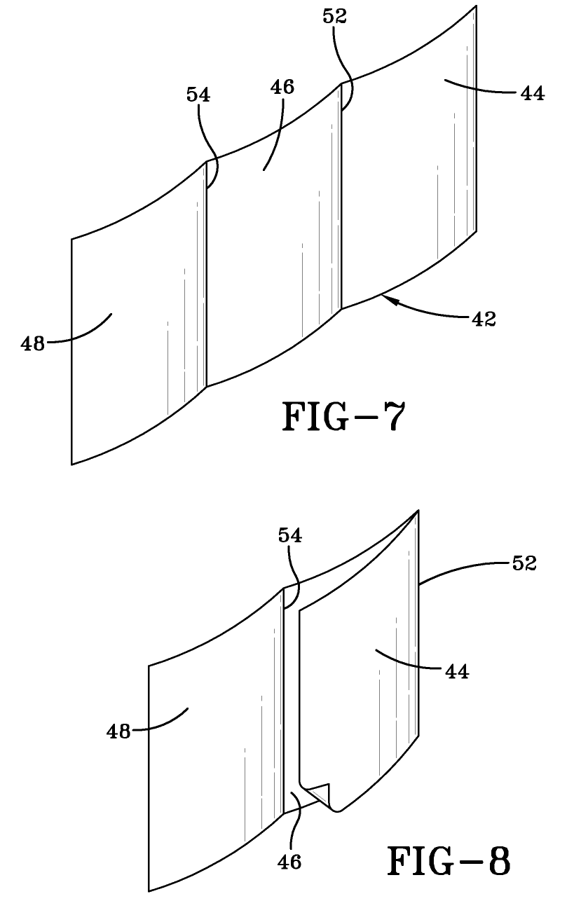

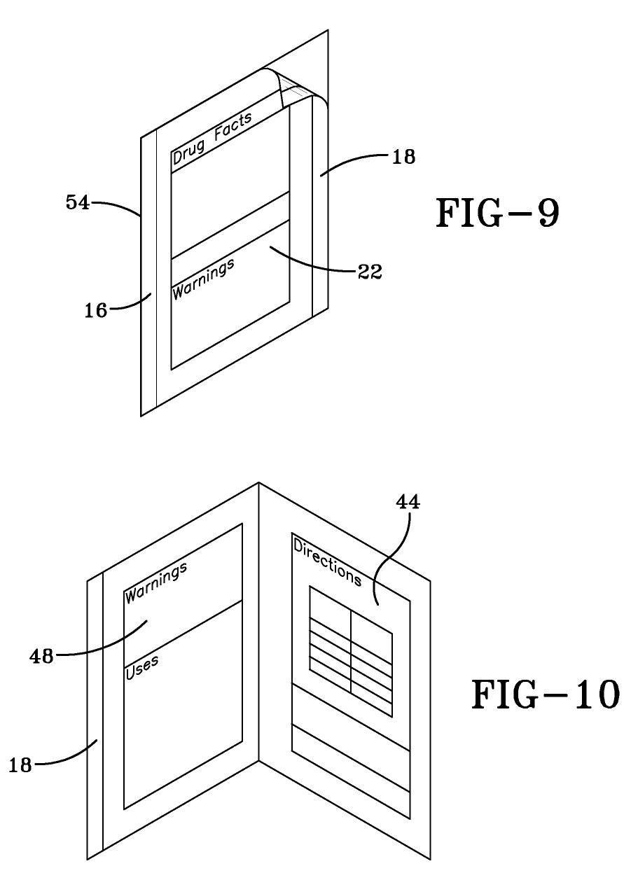

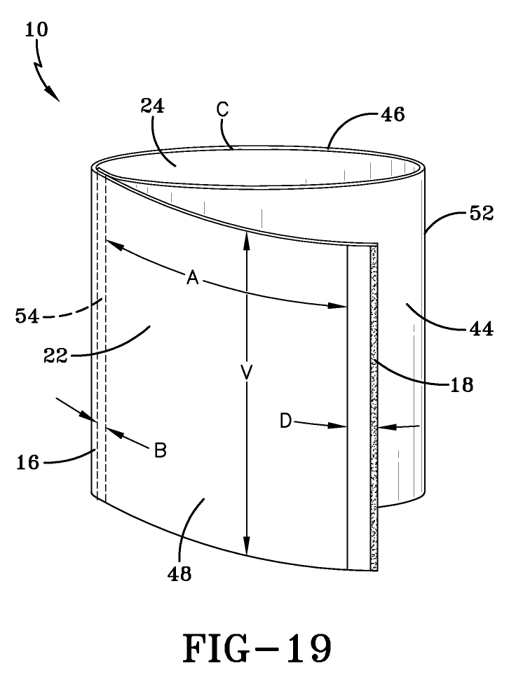

FIG. 7 depicts a single extended text shrink sleeve 42 with section 44, 46, 48 defined by folds 52, 54 to illustrate the first step in fabrication. The overall width of extended text shrink sleeve 10 corresponds to the width of roll 40 depicted in FIG. 6. Folds 52, 54 divide the single extended text shrink sleeve 10 into three sections. The three sections 44, 46, 48 are not necessarily equal in width. The next step of the process forms the shrink sleeve for the container, which in the illustrations provided, is bottle 30. This step involves folding one of the outer sections 44, 48 over middle section 46. The outer section not folded over will form the film text panel 22. In this example, first section 44 is folded over second (middle) section 46. A permanent adhesive/solvent is applied either to middle section 46 along its edge adjacent to fold 54 to join section 44 to section 46 or to the edge of first section 44 in order to join section 44 to second middle section 46 adjacent to fold 54. This adhesive/solvent may be pre-applied prior to folding. Preferably, the adhesive is applied to first section 44 after folding it over middle section 46, as will be explained later. FIG. 8 as well as FIG. 19 (FIG. 19 further depicts a tri-fold) depict the first section 44 folded over middle or second section 46. The lower left edge of first section 44 is raised for illustration purposes. Once the adhesive/solvent has cured, the shrink sleeve portion of the extended text shrink sleeve 10 is complete and the shrink portion of extended text shrink sleeve 10 includes a seam 16. As an alternative to using an adhesive/solvent, seam 16 may be formed by application of heat, such as by use of a heat bar, thereby permanently joining first section 44 to either middle section 46 or to third section 48 adjacent to fold 54. Of course, these figures are illustrations only, and any required printing would already have been accomplished by the graphics supplier. A heat bar can be used to join section 44 to section 46 with or without the use of a heat activated adhesive using techniques well known in the art.

The next step of the process is application of an adhesive strip or other type resealable strip 18 to film text panel 22 so that film text panel 22 can be adhered to and released from the portion of the extended text shrink sleeve 10 applied to bottle 30. Resealable strip 18 can be applied to the right edge of first section 44 in the Figures so that film text panel 22, which is now formed by section 48, can be opened and closed.

FIG. 9 depicts film text panel 22 with resealable strip 18 applied. Preferably, resealable strip 18 is an adhesive strip that also includes a pressure-sensitive adhesive that permits film text panel 18 to be releasably secured onto extended text shrink sleeve 10. A resealable strip that may be used with the present invention is commercially available from Sealstrip Corp. of Boyertown, Pa. The preferred resealable strip 18 is a polypropylene film coated with a pressure sensitive adhesive. The pressure sensitive adhesive preferably is applied to the edge of the film text panel 22 opposite seam 16 so that the pressure sensitive adhesive interfaces with the shrink sleeve portion, although the pressure sensitive adhesive may be applied as well to adjacent edges of the resealable strip substantially perpendicular to seam 16 or any other area of the shrink sleeve portion underlying resealable strip 18. The treated edge of film text panel 22 to which the adhesive resealable strip 18 is applied must be ink and slip coat free, as the pressure sensitive adhesive used to join the adhesive resealable strip 18 to film text panel 22 is adversely affected by ink, adhesive, dirt or other contaminants. The width required for application of resealable strip 18 must be sufficient so that resealable strip 18 will not release during application processes, but still will be able to be used, sealed and resealed multiple times. The resealable adhesive must be of sufficient strength so that it won't pull back from the film during additional processing. Typically the width required for the resealable portion of resealable strip 18 is about 5 mm at the overlap with film text panel 22. Preferably the width required for the resealable strip 18 is about 3 mm, although it may be possible to develop and provide a resealable strip 18 that is as narrow as 1-2 mm. Minimizing the area required for the resealable strip results in increased area available for printed material on film text panel 22. It is preferred that the overall width of resealable strip 18 plus film text panel 22 plus the tab associated with resealable strip 18 is about one third or less of width of film roll 40, the balance of the width being associated with the shrink sleeve itself.

FIG. 10 depicts the extended text shrink sleeve of FIG. 9 with the film text panel 22 in an open position. As can be seen from FIGS. 9-10, printed information can now be included on both sides of film text panel 22 as well as on the shrink sleeve portion of extended text shrink sleeve 10 underlying film text panel 22. Since film text panel 22 is an integral portion of extended text shrink sleeve 10, about three times as much information can now be included on extended text shrink sleeve 10 as compared to an area of a prior art shrink sleeve. A prior art shrink sleeve could provide only an equivalent area of one surface of film text panel 22, unless a plurality of pages is attached, as previously described and set forth in prior art embodiments. However, additional separate instructions in addition to those provided on the extended text shrink sleeve 10 are not required with the present invention since film text panel 22, being an integral portion of extended text shrink sleeve 10, cannot readily be separated from shrink sleeve 10. Extended text shrink sleeve 10 can be fabricated in the form shown in FIGS. 9 and 10 and shipped to a customer for application to the customer's containers.

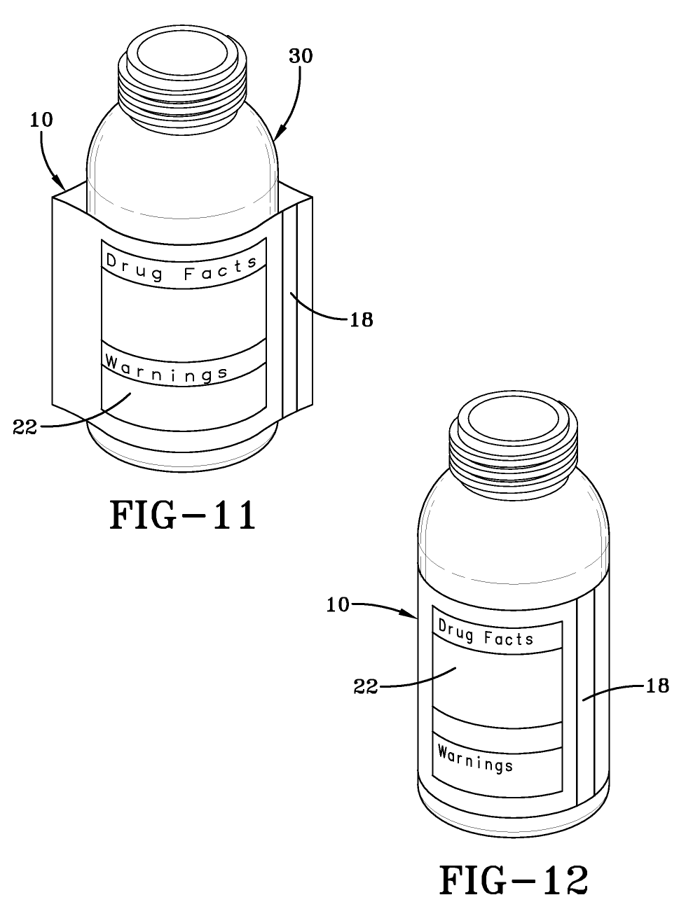

FIG. 11 depicts an elastically elongated extended text shrink sleeve applied to a bottle 30. The operations performed in applying extended text shrink sleeve 10 to packaging such as bottle 30 are typically performed by the customer, and the operations described herein are exemplary. Extended text shrink sleeve 10, having been elastically elongated and then printed upon, can now be subjected to a temperature for shrinking, usually between 80° F.-200° F. The material may be purchased in the deformed or elongated condition. The polymeric material is formed by a process known to those skilled in the art as tentering. As will be understood by those skilled in the art, when this temperature range may include ambient temperatures, the printed labels may be shipped elongated in a refrigerated condition in order to prevent the elastically elongated material from contracting prematurely. As previously discussed, the material used in shrink applications is extended dimensionally in the transverse direction. The material will maintain this extended transverse dimension temporarily until heat within the range identified is applied. Since the material has a size or shape memory, it will attempt to shrink to the original dimension upon application of heat. Once the extended text shrink sleeve 10 is suitably elongated in the transverse direction, printed upon, and formed so that it has the film text panel 22 of the present invention, it is placed over packaging such as bottle 30. It may be possible to print upon the extended text shrink sleeve prior to elongation, so than no allowance for shrinkage in the printing operation is required. Next, heat, most preferably as radiant heat or convection heat, is applied to the printed label, and the extended text shrink sleeve 10 is “shrunk” onto the bottle as it attempts to return to its original dimensions.

FIG. 12 depicts the extended text shrink sleeve 10 of FIG. 11 after it has been shrunk fit onto bottle 30. Extended text shrink sleeve 10, in this example, has the same circumference as bottle 30. The extended text shrink sleeve 10 returns to its original dimensions or takes the shape of bottle 30 and is friction fit onto bottle 30. Alternatively, extended text shrink sleeve 10 may include a heat sensitive adhesive on the inside surface of its circumference, so that when the extended text shrink sleeve 10 is shrunk onto the bottle, it is held in place not only by friction and stress due to the shrink fit but also by the heat activated adhesive. Preferably, the adhesive is a heat-activated adhesive. After extended text heat sleeve 10 is applied to bottle 30, the adhesive can be activated, if it has not already been activated, by raising the temperature of the sleeve and bottle to activate the adhesive.

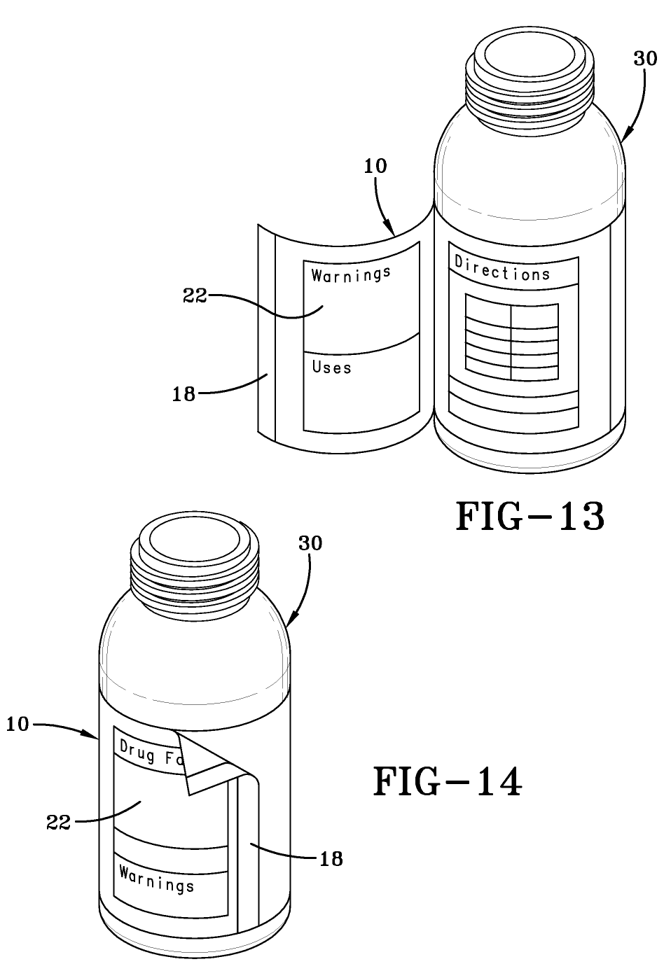

FIG. 13 depicts the extended text shrink sleeve of FIG. 12 with film text panel 22 opened to display printed material on film text panel 22 and on the shrink fit portion of the extended text shrink sleeve 10 underlying film text panel 22. Printed information can now be provided on both sides of film text panel 22 as well as on extended text shrink sleeve 10 underlying film text panel 22. This permits additional instructions to be provided without concerns about the instructions being separated from the container or bottle 30.

FIG. 14 depicts the extended text shrink sleeve of FIG. 12 with film text panel 22 being resealed onto the shrink sleeve portion of extended text shrink sleeve 10. Once the instructions have been reviewed, film text panel 22 can be resealed against the shrink sleeve portion of extended text shrink sleeve 10.

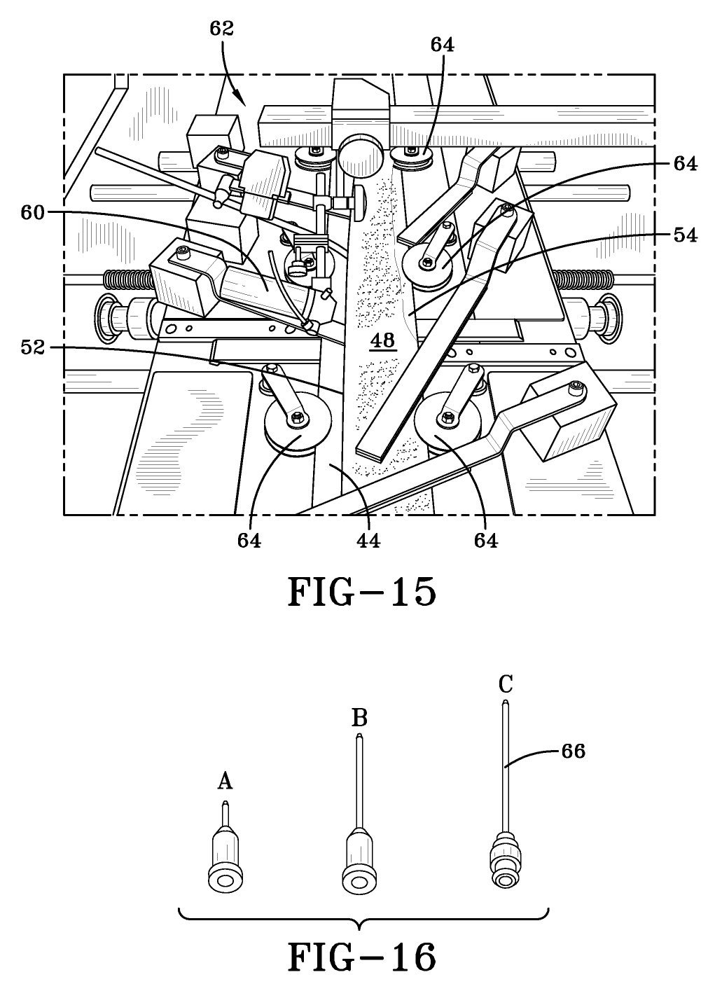

FIGS. 6 through 9 are illustrative of the manipulation of a roll 40 of material to produce an extended text shrink sleeve 10 of the present invention. However, while illustrative of the manipulation, these figures are not representative of the automated equipment and processing methods used to mass-produce the extended text shrink sleeves 10 of the present invention. FIGS. 15 through 18 provide a clearer representation of the automated equipment and processing used to mass-produce the extended text shrink sleeves 10 of the present invention. FIG. 15 is a view of automated machinery for forming extended text shrink sleeve 10 of the present invention, the machinery applying an adhesive to the roll 40 of FIG. 6 after folding a length of the roll 40 in accordance with FIG. 7. In FIG. 15, sheet from the film roll 40 has been dispensed onto machine 62 and folded into three sections. The width of the film roll is larger than has been used by prior art processes for fabricating shrink sleeve labels. The width of the film roll is determined by the size of the packaging and the size of the film text panel. The width is the sum of the sleeve portion, in the unstretched condition, and the film text panel. Second section 46 faces the platen of the machine and is not visible in FIG. 15. However, first section 44, having a first or distal edge and a second opposed or proximal edge, is shown folded over second section 46, having a first or proximal edge that corresponds to or is coextensive with the proximal edge of first section 44, and a second opposed or distal edge, underneath third section 48, having a proximal edge that corresponds to or is coextensive with the second distal edge of second section 46. Also visible is an adhesive application tool 60 extending underneath third section 48. Projecting from adhesive application tool 60 is a needle 66 (not visible in FIG. 15) that extends underneath and across third section 48. This needle 66 differs from prior art needles used to fabricate shrink fit labels in that it is longer, since it must extend all the way across the folded material in order to apply an adhesive in an effective amount onto the film adjacent to fold 54 as one exemplary method of joining first section 44 to second section 46 to form a sleeve portion. The folded material from roll 40 is advanced by a plurality of rollers 64 so that adhesive can be applied to form a seam in a continuous fashion. FIG. 16 depicts the seaming needle 66 adjacent to prior art needles, labeled A and B, used for adhesive application. Seeming needle 66 was developed for applying an adhesive to form a seam adjacent to fold 54 in the automated process for fabricating the extended text shrink sleeve 10 of the present invention. Needle A is a standard application needle, while needle B is about 1.5 inches in length. Seeming needle 66 will vary in size depending on the position of fold 54. In this example, needle 66 is 2 inches in length.

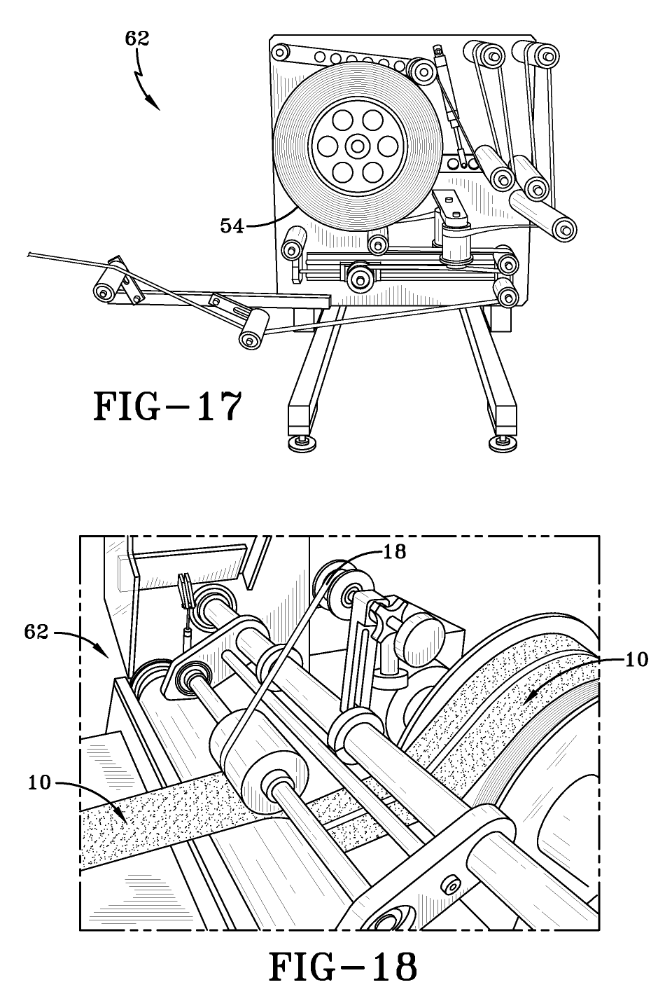

FIG. 17 depicts a roll of resealable strip 18 assembled to the automated machine 62 for fabricating the extended text shrink sleeve 10 of the present invention. The roll of resealable strip 18 is adjacent to rollers in FIG. 17. Referring now to FIG. 18, which depicts application of resealable strip 18 to extended text shrink sleeve 10 thereby completing the extended text shrink sleeve 10 of the present invention, extended text shrink sleeve 10 from FIG. 15 is fed through rollers. As the extended text shrink sleeve is fed through one set of rollers, resealable strip 18 is fed through a second set of rollers more clearly seen in FIG. 17, onto the edge of film text panel 22 and adhered to it. This completes the automated fabrication of extended text shrink sleeve 10. The extended text shrink sleeve 10 can be provided to the customer as requested. It can be rolled onto a separate roll and shipped in this form to the customer, in which case it is likely that a perforation will be added between each individual extended text shrink sleeve 10 to simplify separation of each extended text shrink sleeve 10 by the customer. Alternatively, the customer may desire to have the extended text shrink sleeve 10 cut into individual units and shipped in a box, each box including a plurality of individual extended text shrink sleeves 10.

FIG. 19 is a perspective view of a fabricated extended text shrink sleeve 10 prior to application to container. The extended text shrink sleeve 10 will ship as a roll, or as individual units, cut and boxed in accordance with customer specifications. However the perspective view of FIG. 19 clearly depicts the film text panel 22 which permits the addition of additional printed instructions. First section 44 is turned over at fold 52 over second section 46 and adhered to third section 48 to form seam 16 adjacent to fold 54. After formation of seam 16, the shrink sleeve portion 24 of the extended text shrink sleeve 10 and the film text panel 22 are formed. Resealable strip 18 is applied at an edge of the third section 48 which now forms the film text panel 22, so that film text panel 22 can be repeatedly opened and closed against shrunk sleeve portion 24 to access additional printed information.

### Example

Referring again to FIG. 19, an extended text shrink sleeve of the present invention after shrinking is depicted. Dimension A is the width of film text panel 22. In one preferred embodiment, the width of the film text panel is 76 mm. It will be understood that dimension A can be varied depending upon the information required on the label, which in turn dictates the size of the label and the size required for the shrink fit. Thus, the present invention provides an additional 152 mm (76×2) of width for printing than a conventional label. The additional overall area available for printing with the present invention in this example would be the width of film text panel 22 multiplied by the vertical dimension V of extended text shrink sleeve 10. Dimension B is the width of inside seam 16 that forms the circumference or sleeve opening and delineates the border between this sleeve opening and film text panel 22. In this example, Dimension B is 5 mm. Dimension C is the circumference of the sleeve opening after the sleeve is shrunk by the shrink fit process, which shrinks the sleeve onto a container. This circumferential dimension in this example is 96 mm. Resealable strip 18 includes an adhesive. Dimension D represents the width of adhesive portion of resealable strip, which is 2 mm. Each of these dimensions is exemplary, and can be varied depending upon the application.

Because the present invention includes film text panel 22, the starting film roll 40 is wider than film rolls utilized in fabricating prior art labels. The width of the starting film roll must be equal to the sum of the exterior dimensions or circumference of the packaging plus the width of film text panel 22. The present invention also provides the advantage of automated fabrication. This fabrication uses existing machinery with modifications to permit the use of wider film rolls. The machinery is further modified to fold the film rolls and to apply an adhesive at an edge or to permit heat sealing across the width of the folded film rolls. The machinery also includes some additional equipment to permit application of resealable strip 18.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A resealable extended text film panel system, comprising:
a shrink sleeve portion;
a film text panel, wherein the shrink sleeve portion is integral with the film text panel;
a seam formed between the shrink sleeve portion and a first end of the film text panel delineating the shrink sleeve portion from the film text panel;
a resealable strip cooperating with an edge of the film text panel, wherein the film text panel can be unsealed from and sealed to the shrink sleeve portion a plurality of times, and
wherein the shrink sleeve portion and the film text panel are further comprised of a printable material.

2. The resealable extended film panel system of claim 1 wherein at least one of the shrink sleeve portion and the film text panel include text or graphics.

3. The resealable extended film panel system of claim 1 wherein the shrink sleeve portion and the integral film text panel comprise a material having a shape memory.

4. The resealable extended film panel system of claim 1 wherein the shrink sleeve portion and the integral film text panel comprise a material selected from the group consisting of polyvinyl chloride, polyethylene terephthalate, oriented polystyrene and polylactide.

5. The resealable extended film panel system of claim 1 wherein the resealable strip is affixed to an edge of the film text panel.

6. The resealable extended film panel system of claim 1 wherein the resealable strip is affixed to the shrink sleeve portion.

7. A packaging system, comprising:
a package having an exterior surface;
a resealable extended text film panel system applied to the package, the extended text film panel system including
a sleeve portion that extends around the exterior surface of the package,
a film text panel, the film text panel being integral with the sleeve portion of the resealable film text panel system,
a seam formed between the sleeve portion and a first end of the film text panel, the film text panel extending away from the seam and overlapping a portion of the sleeve portion,
a resealable strip cooperating with an edge of the film text panel so that the film text panel can be unsealed from and sealed to the sleeve portion a plurality of times, and
wherein the film text panel and at least the portion of the sleeve portion overlapped by the film text panel are comprised of printable material.

8. The packaging system of claim 7 wherein the resealable strip is selected from the group consisting of pressure sensitive adhesive, Velcro® strip, magnetic strip and static recharge strip.

9. The resealable strip of claim 8 wherein the width of overlap for cooperation between the film text panel and the sleeve portion is greater than about one mm.

10. The packaging system of claim 7 wherein the sleeve portion that extends around the exterior of the packaging further includes an adhesive for adhering the sleeve portion to the packaging.

11. The packaging system of claim 7 wherein the sleeve portion that extends around the exterior of the packaging is a shrink sleeve portion so that the sleeve portion can be shrunk around the packaging.

12. A method of forming a resealable extended text film panel system, comprising the steps of:
providing a roll of a stretchable film material having a preselected width;
folding the film material into a first portion having a distal edge and a proximal edge, a second portion having a first proximal edge corresponding to the proximal edge of the first portion and a second distal edge, and a third portion having a proximal edge corresponding to the distal edge of the second portion and a distal edge;
joining the distal edge of the first portion to the second portion along a seam, thereby forming a sleeve portion, the third portion extending from the seam and overlapping the sleeve portion, the third portion forming a film text panel;
applying a resealable strip so that the sleeve portion cooperates with the film text panel, allowing the resealable strip to be sealed to the sleeve portion;
stretching the film material; and
applying printed characters to at least one of the film text panel and the sleeve portion overlapped by the film text panel.

13. The method of claim 12 wherein the step of joining the distal edge of the first portion to the second portion along a seam further includes applying an adhesive/solvent to the film material to form the seam.

14. The method of claim 12 wherein the step of joining the distal edge of the first portion to the second portion along a seam further includes heat sealing the first portion to the second portion along the seam.

15. The method of claim 12 further including the step of cutting the material into labels of preselected size while in stretched condition and shipping the labels in the stretched condition.

16. The method of claim 12 wherein the step of stretching the film material includes cooling and tensioning to controllably stretch the material.

17. The method of claim 12 wherein the step of providing a stretchable film material includes providing a material having a shape memory.

18. The method of claim 12 wherein the step of providing a material of preselected width includes determining the preselected width based on the sum of the unstretched final size of the sleeve portion and the film text portion

19. The method of claim 12 further including the steps of providing a packaging container, applying the sleeve portion around the packaging container and then shrinking the stretched material around the packaging container.

20. The method of claim 12 wherein the film text panel comprises up to one third of the preselected width of the stretchable film material.
